(19) United States
(12) Patent Application Publication
(10) Pub. No.: US 2024/0102390 A1
(43) Pub. Date: Mar. 28, 2024

(54) METHOD FOR MANUFACTURING A HOLLOW PART

(71) Applicant: SAFRAN, Paris (FR)

(72) Inventors: Enrico Giovanni OBERT, Moissy-Cramayel (FR); Adrien TOUZE, Moissy-Cramayel (FR)

(21) Appl. No.: 17/753,579

(22) PCT Filed: Sep. 11, 2020
(86) PCT No.: PCT/FR2020/051576

§ 371 Date: Mar. 8, 2022

(30) Foreign Application Priority Data
Sep. 13, 2019 (FR) FR1910118

(51) Int. Cl. F01D 5/18; B29C 37/00; B29C 70/24; B29C 70/48

(52) U.S. Cl. CPC F01D 5/18; B29C 37/0017; B29C 70/24; B29C 70/48; B29K 2105/0845; F05D 2230/30; F05D 2240/12; F05D 2300/6034

(57) ABSTRACT

The invention relates to a method for manufacturing a hollow part made of composite material for an aircraft turbomachine, wherein: a) a preform is produced by the three-dimensional weaving of threads; b) the preform is cut so as to provide a separation; c) the cut preform is deformed so as to provide an orifice then comprising a first and a second open end (27a, 27b); d) the deformed preform is placed into an injection mould; e) a resin is injected in order to impregnate the whole of the deformed preform; f) the resin is polymerised; and g) a composite part is extracted from the mould; characterised in that: h) a flexible mandrel (31) with a predetermined shape is positioned in the orifice before the injection step e); i) the flexible mandrel (31) is removed after step f) or the demoulding step g), the composite part then having a hollow core (25).

### TECHNICAL FIELD OF THE INVENTION

The present invention relates to a method for manufacturing a hollow part in composite material for an aircraft turbomachine. The present invention also relates to a profile bladed element, such as a stator vane, obtained by such a method and a tooling for carrying out this method.

### BACKGROUND

The prior art comprises, in particular, the documents US-A1-2016/082674, FR-A1-2 559 423 and FR-A1-3 013 252 A1.

The conventional dual flow turbomachines can have several types of stators. In the primary flow duct, they comprise stators whose vanes, due to their reduced dimensions, are made in the form of single-piece or assembled metal elements, which are produced by a casting process. The rigidity of these vanes is ensured by a substantial amount of metal or a 3D geometry adjusted to give them the necessary rigidity.

The problem is different in the case of outlet guide vanes (OGVs), which are located in the secondary flow duct of the turbomachine, because they are large vanes that cannot be produced using a casting process, because the large quantities of metal that would then be used would give them an extremely high mass, which has the effect of weighing down the turbomachine and degrading its aerodynamic performance. Metallic OGVs with a hollow core have also been proposed, but such OGVs still have unsatisfactory mass.

OGVs can also be made of composite materials. For example, these are vanes made by successive draping, around a central core made of a foam or honeycomb type material, of pre-impregnated composite fabric plies, these plies subsequently undergoing a polymerisation operation. The vanes can also be made by three-dimensional weaving of carbon fibre-based fabric preforms, followed by injection of resin into these preforms, and then polymerisation of the preforms thus impregnated.

This composite structure offers a good mechanical strength/mass ratio which is not, however, sufficient for turbomachines with large diameters, and therefore very large OGVs. Indeed, beyond a certain diameter of the turbomachine, a composite OGV made in this way has a mass similar to a hollow metal OGV.

The present invention therefore aims to propose a solution that optimises the gain in mass and reduces the manufacturing cost of such a composite structure.

### SUMMARY OF THE INVENTION

To this end, the invention relates to a method for manufacturing a hollow part made of composite material for an aircraft turbomachine, the method comprising the following steps:
a) a preform is produced by three-dimensional weaving of threads;
b) said woven preform is cut so as to provide an internal separation;
c) said cut preform is deformed so as to provide an orifice from the internal separation, the deformed preform then comprising a first open end and a second open end opposite the first end;
d) said deformed preform is placed in an injection mould;
e) a binder comprising a resin is injected into said injection mould in order to impregnate the whole of the deformed preform;
f) the resin is polymerised; and
g) a composite part is extracted from the mould;
this method being characterised in that it further comprises the following steps:
h) a flexible mandrel having a predetermined shape is positioned in the orifice provided in the deformed preform from one of the first and second open ends before the resin injection step e);
i) the flexible mandrel is removed from one of the first and second open ends after the resin polymerisation step f) or after the demoulding step g), the composite part then having a hollow core.

The method according to the invention thus allows to produce structural parts which have all the properties of composite parts and their advantages, while guaranteeing an even greater gain in mass compared with solid composite parts or even metal parts. In addition, the method allows to obtain parts that are more hollow where they are less mechanically stressed and vice versa so as to optimise the mechanical properties of the parts in the most stressed areas.

Advantageously, the method comprises a preliminary step of treating the flexible mandrel with a liquid release agent.

This facilitates the demoulding of the flexible mandrel in the removal step i).

Preferably, the method further comprises, after the step c) of deforming the cut preform, a step c′) of positioning a gap filler at the other of the first and second open ends, the steps h) of positioning the flexible mandrel and i) of removing the flexible mandrel are carried out through the opposite open end.

This gap filler allows to fill the opening at the other of the first and second open ends to ensure its sealing.

Preferably and advantageously, the method further comprises, after the step c′) of positioning a gap filler at said other of the first and second open ends, a step c″) of positioning a counter plate at the other of the first and second open ends.

Advantageously, the method comprises a step j) of closing one of the first and second open ends of the hollow composite part so as to guarantee the sealing of the hollow part thus formed.

According to one example of embodiment, step j) of closing one of the first and second open ends of the hollow part is performed by plugging with a cold resin.

According to another example of embodiment, the step j) of closing one of the first and second open ends of the hollow part is performed by bonding a preformed composite counter plate.

The present invention also relates to a profile bladed element, such as a stator vane, for a propulsion assembly, characterised in that it is obtained according to the method having any of the above-mentioned characteristics.

Such a bladed element has an even more optimised mechanical strength/mass ratio compared to solid bladed elements of the prior art.

The present invention also relates to a tooling for manufacturing a hollow part made of composite material for an aircraft turbomachine, characterised in that it comprises a flexible mandrel, for example made of silicone, configured for carrying out the method according to the invention.

With such a flexible mandrel, this tooling has the interesting advantage of being able to allow the manufacture of parts with a hollow core and complex shapes (such as the pressure side and suction side) giving the aerodynamic shape to the bladed elements, and having thin walls, for which it would not be possible to use a rigid insert, the latter then being undetachable.

Advantageously, the tooling also comprises an insert configured to ensure the sealing at injection of an excess length which the flexible mandrel presents, enabling it to be gripped in the positioning step h) and the removal step i).

In this way, the excess length of the mandrel is not impregnated with resin during the injection step e), which allows the mandrel to be easily removed during the step i).

### BRIEF DESCRIPTION OF THE FIGURES

Further features and advantages of the invention will become apparent from the following detailed description, for the understanding of which reference is made to the attached drawings in which:

FIG. 1 is a schematic view, in longitudinal section, of a propulsion assembly;

FIG. 2 is a perspective view of a vane of an intermediate casing of the propulsion assembly, the vane comprising a blade;

FIG. 3 is a schematic cross-sectional view of a blade according to the invention;

FIG. 4a is a view analogous to FIG. 3, showing a three-dimensional preform;

FIG. 4b is a view analogous to FIG. 4a, showing the three-dimensional preform having an internal separation;

FIG. 4c is a similar view to FIG. 4a, showing the three-dimensional preform in the process of being deformed;

FIG. 5 is a schematic view in longitudinal section of a vane according to the invention in which the mandrel is inserted;

FIG. 6 is a schematic view in radial section of a vane according to the invention into which the mandrel is inserted;

FIG. 7 is a view similar to FIG. 8 showing the mandrel being withdrawn;

FIG. 8 is a detail view of a vane and tooling according to the invention.

### DETAILED DESCRIPTION OF THE INVENTION

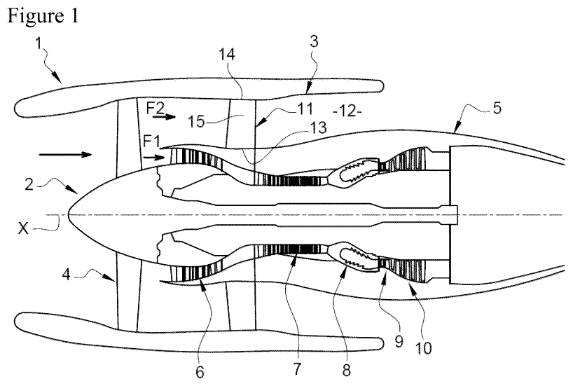

FIG. 1 shows a propulsion assembly 1, in particular for an aircraft, comprising a dual flow turbomachine 2 integrated in an annular external casing 3. The turbomachine 2 comprises, from upstream to downstream in the direction of gas flow, a fan 4 and a gas generator 5 comprising one or more compressor stages, low pressure 6 and high pressure 7, a combustion chamber 8, one or more turbine stages, high pressure 9 then low pressure 10, and an exhaust nozzle. The rotors of the turbomachine 2 are mobile in rotation about a longitudinal axis X of the turbomachine 2.

In the present case, the external casing 3 comprises in particular a fan casing, an intermediate casing 11 and a nacelle.

By convention in the present application, “longitudinally” or “longitudinal” means any direction parallel to the axis X, and “radially” or “radial” means any direction perpendicular to the axis X. Similarly, by convention in this application, the terms “internal” and “external” are defined radially with respect to the axis X.

The airflow driven by the fan 4 is separated into a primary airflow F1 entering the gas generator 5 of the turbomachine 2 and a secondary airflow F2 contributing predominantly to the thrust provided by the turbomachine 2. The secondary airflow F2 flows around the gas generator 5 in a secondary duct 12.

The intermediate casing 11 is located longitudinally between the low-pressure compressor 6 and the high-pressure compressor 7, this casing 11 comprising an inner shroud 13, and an outer shroud 14 extending around the inner shroud 13 and forming with the latter a portion 32 of the secondary duct 12. The outer shroud 14 is rigidly connected to the inner shroud 13 by arms 15 which are substantially radial with respect to the longitudinal axis X of the turbomachine 2, distributed in a uniform manner, and between which there are guide vanes 16 known as OGVs for “Outlet Guide Vane”.

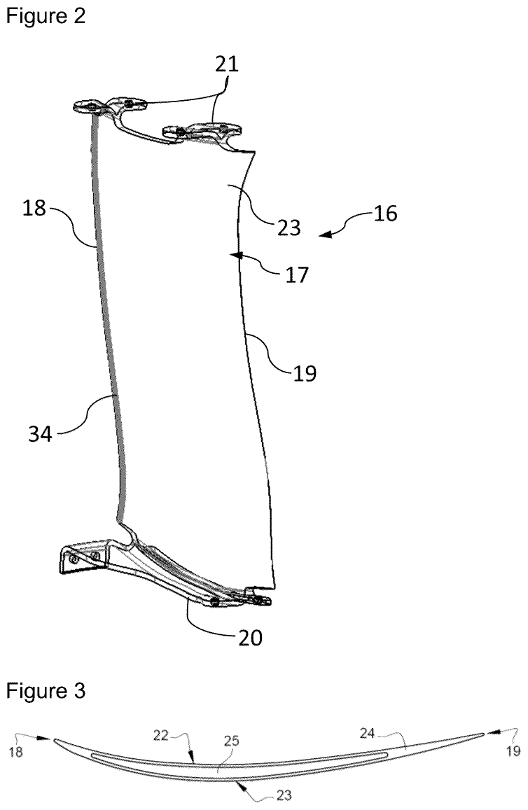

As illustrated in FIG. 2, the OGV vane 16 comprises a blade 17 with an aerodynamic profile, of elongated shape, delimited longitudinally by a leading edge 18 arranged upstream in the direction of flow of the gases in the intermediate casing 11, and by a trailing edge 19 opposite the leading edge 18. The blade 17 is further delimited radially between an inner platform 20 and an outer platform 21. More precisely, the inner platform 20 and outer platform 21 are respectively intended to be mounted on the inner shroud 13 and outer shroud 14 of the intermediate casing 11. The blade 17 is laterally delimited by a pressure side face 22 and a suction side face 23, these pressure side face 22 and suction side face 23 connecting the leading edge 18 and the trailing edge 19. The pressure side face 22 and suction side face 23 are curved, and respectively concave and convex.

The blade 17 comprises, structurally, a shell 24 made of shaped composite material and an internal hollow core 25 of elongated shape, substantially reproducing the shape of the shell 24. The hollow core 25 to be formed in the vane 16 can thus have a complex three-dimensional shape due to the outer surfaces (pressure side 22 and suction side 23) which have an aerodynamic function. The hollow core 25 is also capable of absorbing variations in the thickness of the shell 24 in order to maintain a substantially constant thickness on the walls (pressure side 22 and suction side 23) of the shell 24.

According to the illustrated example, the invention applies to an OGV vane 16 but it could be applied to the various profile bladed elements (of the rotor or stator) included in the propulsion assembly 1 or to any composite part comprising an external shell having a complex shape and a hollow core.

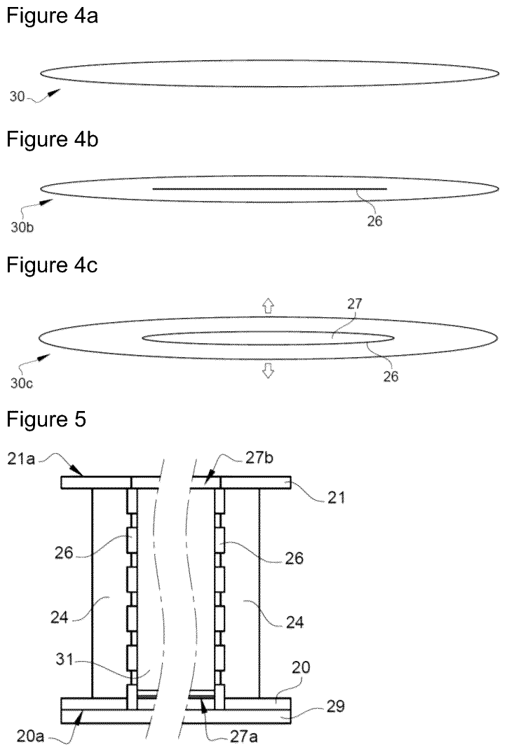

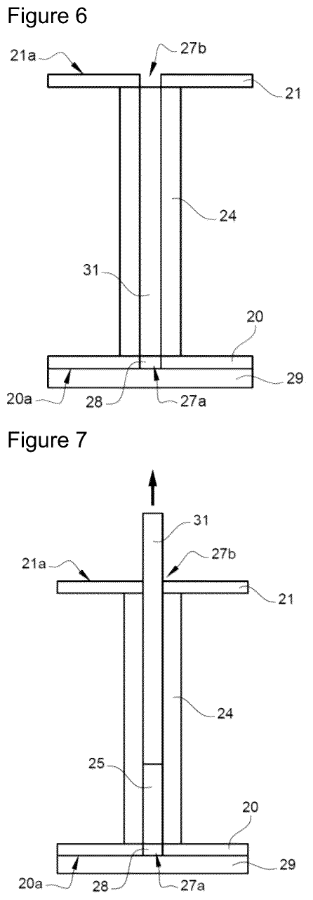

The method of manufacturing an OGV vane 16 will now be described with reference to FIGS. 4a to 8.

The method in accordance with the present invention is carried out starting from a preform 30a such as that resulting from a three-dimensional weave made, for example, in accordance with FR 2 861 143. Thus, the first step a) of the method consists in making such a three-dimensional preform 30a by weaving (illustrated in cross-section in FIG. 4a), which comprises warp threads and weft threads. In these two groups of threads, tracer threads are provided which are visually identifiable from the others and are regularly located at least on the surface of the preform. Advantageously, said preform is formed of warp threads and weft threads, the direction of the warp threads forming the longitudinal direction of the preform, said preform comprises at least a first part forming the blade 17 of the vane 16, a second part forming the inner platform 20 of the vane 16 and a third part forming the outer platform 21 of the vane 16.

The weaving yarns belong to the group consisting of carbon fibres, glass fibres, silica fibres, silicon carbide fibres, alumina fibres, aramid fibres and aromatic polyamide fibres.

This one-piece woven preform 30a is then cut according to the step b) of the method according to the invention. More precisely, this woven preform 30a is cut so as to provide an internal separation 26. This cutting may be carried out by any means known per se, such as laser cutting, for example. The result is a cut preform 30b shown in cross-section in FIG. 4b.

This internal separation 26 allows the deformation of the cut preform 30b in the step c) of the method according to the invention so as to provide an orifice 27, the start of the hollow core 25 of the vane 16. This orifice 27 passes longitudinally through so as to create a first open end 27a at the level of the inner platform 20 and a second open end 27b opposite the first end, in other words at the level of the outer platform 21. This results in a deformed preform 30c shown in cross-section in FIG. 4c.

Advantageously, it is possible to fill the first open end 27a at the inner platform 20. Thus, the method according to the invention may comprise, after the step c) of deforming the cut preform 30b to obtain the deformed preform 30c, a step c′) of positioning a gap filler 28 at the first open end 27a. This gap filler 28 is in the form of a carbon braid and allows the sealing of this first open end 27a.

Furthermore, as the internal platform 20 is the most mechanically stressed, it may be advantageous to use a counter plate 29 to increase its mechanical strength. Thus, the method according to the invention may still comprise, after the step c′) of positioning a gap filler 28 at the first open end 27a, a step c″) of positioning a counter plate 29 at this first open end 27a, against an internal surface 20a of the internal platform 20.

The gap filler 28 positioned so as to be flush with the inner surface 20a of the inner platform 20 provides a substantially flat surface when positioning the counter plate 29 against the inner surface 20a of the inner platform 20.

The deformed preform 30c, thus provided with the gap filler 28 and the counter plate 29 at the first open end 27a is then placed in an injection mould in a step d).

The deformed preform 30c is held in the injection mould by any means known per se.

A flexible mandrel 31 having a predetermined shape is then positioned in the orifice 27 in the deformed preform 30c in a step h). The flexible mandrel 31 is inserted into the orifice 27 from the second open end 27b opposite the first open end 27a.

Advantageously, the flexible mandrel 31 has a shape substantially identical to the shape of the hollow core 25 to be made inside the vane 16. The complex shape of the vane 16 and the thicknesses of the walls of the shell 24 of the vane 16 induce the use of a flexible mandrel 31 because such a mandrel which would be rigid would be undetachable (during a step i) of removal of the flexible mandrel described below), due to its shapes also complex.

The flexible mandrel 31 is also configured to compact the deformed preform 30c within which it is inserted to a predetermined thickness. In particular, the preform is compacted between a rigid outer mould and a centrally located silicone core.

In a step e), a binder comprising a resin is injected into the injection mould comprising the deformed preform 30c in which the flexible mandrel 31 is inserted in order to impregnate the entire deformed preform 30c. This binder is, for example, injected into the injection mould from the internal platform 20.

If a counter plate 29 is positioned against the inner surface 20a of the inner platform 20 of the vane 16, then this counter plate is also co-injected with binder in the step e).

The presence of the gap filler 28 ensures the sealing function of the vane 16 at the internal platform 20 from the injection step e). This injection step is known per se in the process of manufacturing parts made of composite materials by resin transfer moulding (RTM). The injected binder is then polymerised in a manner known per se in a step f).

The flexible mandrel 31 is held in position inside the deformed preform 30c during the injection step e) and binder polymerisation step f). Advantageously, the flexible mandrel 31 is configured to withstand the injection pressure of the binder injected in the step e). The flexible mandrel 31 is for example made of silicone.

After the polymerisation step f), the composite vane 16 is removed from the injection mould in step g).

The removal of the flexible mandrel 31 during a step i) can be done:
either after the step f) of polymerisation of the resin,
or after the step g) of demoulding the vane 16.

After this step i) of removing the flexible mandrel 31, the composite vane 16 has the hollow core 25.

The flexible mandrel 31 is withdrawn from the hollow core 25 from the second open end 27b opposite the first open end 27a, this withdrawal movement being illustrated by the arrow in FIG. 7. The flexible mandrel 31 is further configured to have tensile properties to provide the necessary tear strength during the removal step i) the demoulding operation.

In order to facilitate the demoulding of the flexible mandrel 31 during the removal step i), it is advantageous to treat the flexible mandrel 31 beforehand with a liquid release agent in order to avoid any sticking between the flexible mandrel 31 and the resin injected in the step e).

The flexibility of the flexible mandrel 31 allows it to be easily removed from the hollow core 25 even if the latter has complex shapes.

Advantageously, the flexible mandrel 31 may have an excess length 31a facilitating the handling of the flexible mandrel 31, particularly during the removal step i).

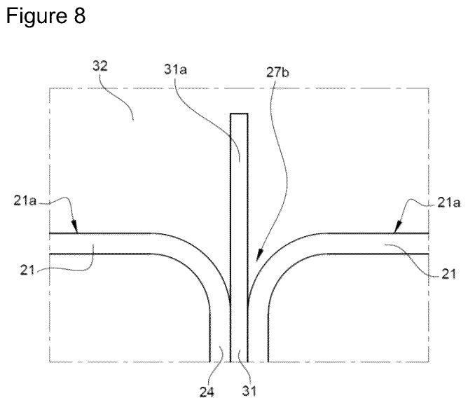

The injection mould for implementing the method according to the invention may then advantageously comprise an insert 32 configured to be positioned at the second open end 27b facing the external surface 21a of the platform 21, so as to surround the excess length 31a when the flexible mandrel 31 is positioned inside the orifice 27 of the deformed preform 30c, as illustrated in FIG. 8. The insert 32 provides a sealing at injection for the excess length 31a of the flexible mandrel 31. Thus, the excess length 31a is not impregnated with binder during the injection step e) so that the flexible mandrel 31 is easily accessible for the removal step i).

According to an embodiment not shown, the insert 32 comprises channels for injecting the binder into the injection mould in the injection step e).

Finally, the second open end 27b of the vane 16 is closed in a step j) so as to ensure the sealing of the hollow vane 16 thus formed. This closure may, for example, be carried out either by plugging with a cold resin or by fixing, for example by gluing, a preformed composite counter plate (not shown) against an external surface 21a of the internal platform 20.

According to another embodiment, the counter plate 29 could not be inserted into the injection mould with the deformed preform 30 but could be added after the manufacture of the vane 16. A composite counter plate (already injected with binder) could then be fixed, in a manner known per se, for example by gluing, against the inner surface 20a of the inner platform 20.

1. A method for manufacturing a hollow part made of composite material for an aircraft turbomachine, the method comprising the following steps:
a) a preform is produced by three-dimensional weaving of threads;
b) said woven preform is cut so as to provide an internal separation;
c) said cut preform is deformed so as to provide an orifice from the internal separation, the deformed preform then comprising a first open end and a second open end opposite the first end;
d) said deformed preform is placed in an injection mould;
e) a binder comprising a resin is injected into said injection mould in order to impregnate the whole of the deformed preform;
f) the resin is polymerised; and
g) a composite part is extracted from the mould;
this method being characterised in that it further comprises the following steps:
h) a flexible mandrel having a predetermined shape is positioned in the orifice provided in the deformed preform from one of the first and second open ends before the resin injection step e);
i) the flexible mandrel is removed from one of the first and second open ends after the resin polymerisation step f) or after the demoulding step g), the composite part then having a hollow core.

2. The method according to claim 1, wherein it comprises a preliminary step of treating the flexible mandrel with a liquid release agent.

3. The method according to claim 1, wherein it further comprises, after the step c) of deforming the cut preform, a step c′) of positioning a gap filler at the other of the first and second open ends, the steps h) of positioning the flexible mandrel and i) of removing the flexible mandrel being carried out through the opposite open end.

4. The method according to claim 3, wherein it further comprises, after the step c′) of positioning a gap filler at said other of the first and second open ends, a step c″) of positioning a counter plate at the other of the first and second open ends.

5. The method according to claim 1, wherein it comprises a step j) of closing one of the first and second open ends of the hollow composite part.

6. The method according to claim 5, wherein the step j) of closing one of the first and second open ends of the hollow part is performed by plugging with a cold resin.

7. The method according to claim 5, wherein the step j) of closing one of the first and second open ends of the hollow part is performed by bonding a preformed composite counter plate.

8. A profile bladed element, such as a stator vane, for a propulsion assembly, wherein it is obtained according to the method of claim 1.

9. (canceled)

10. (canceled)
